(19) United States
(12) Patent Application Publication
(10) Pub. No.: US 2005/0100139 A1
(43) Pub. Date: May 12, 2005

(54) Telephone recording announcer

(76) Inventors: Alan Morse, Monrovia, CA (US); Steven B. Darrow, Arcadia, CA (US); Alex Bal-Ut, San Gabriel, CA (US)

Correspondence Address: Gordon & Rees, LLP, Suite 2075, 300 S. Grand Ave., Los Angeles, CA, 90071, US

(21) Appl. No.: 10/703,995

(22) Filed: Nov. 7, 2003

(51) Int. Cl. H04M 11/00; H04M 1/64

(52) U.S. Cl. 379/68; 379/88.16

(57) ABSTRACT

A telephone recording announcer which has a playback circuit that, when activated, outputs voice storage to a microphone circuit that can be located in a telephone apparatus to which the announcer is connected. The playback circuit is activated by a switch or switches including but not limited to a push button switch and/or an activation switch. The activation switch is linked to the handset of the telephone apparatus by a beam of radiation emitted from a transmitter/detector unit that is attached to the announcer and that is reflected by a reflector on the handset to a sensor attached to the announcer. When the handset is in an off-hook position, the beam of radiation no longer contacts the sensor and the playback circuit is activated. Voice storage is then released to the microphone circuit.

### FIELD OF INVENTION

The field of this invention concerns a telecommunications device. In particular, the present invention relates to a telephone recording announcement activated when the telephone handset senses certain on-hook and off-hook conditions.

### BACKGROUND OF THE INVENTION

Telephone recordings have been used in the past to greet callers when the person dialed is unavailable. They have also been used to direct callers when a caller calls at a time at which there is heavy phone traffic and a person is not available to receive the call.

In order to protect call recipients or the callers themselves, it has become necessary to automate this feature such that callers always hear the same greeting with a message containing information deemed to be important. Such information may include a disclaimer indicating the phone call is being recorded, company identification such as a slogan, or operator identification so that callers are aware of the operator's identity in the event of a disconnected call or for future reference.

The prior art has limitations in that the recording playback is not prompted by the on-hook/off-hook state of the handset. Additionally, prior art systems often place the onus on the operator to perform the tedious task of giving the standard generic information to each and every caller or triggering playback of messages manually. Prior art systems are also often compatible only with a limited number of phone systems and/or are difficult to retrofit to existing systems.

### SUMMARY OF INVENTION

The telephone recording announcer is intended to overcome the aforementioned shortcomings. It is therefore an object of this invention to activate a pre-recorded telephone message to callers when the recipient picks up his/her handset which would assure that every caller would receive the same clear and consistent answer each time they placed a call to that particular recipient of the call.

A further object of this invention is that a caller, when placing a call, would be able to press a button to activate the feature whereby the announcement would be played when a recipient answered the call so that the recipient would be aware of the identity of the caller and any additional information or disclaimers the caller would like to relay to the recipients.

A further object of this invention is that the feature whereby the recording played for callers or call recipients is activated any time the phone senses that the handset goes from on-hook to off-hook. This prevents the ability of the operator to by-pass the recording or forget to play the recording because each time the phone is taken off the hook, the recording would be played automatically to the caller.

A further object of this invention is that the press button can be used in instances when the user is on the other line and the handset is already off-hook or in the event that the user activates other features whereby the handset is not removed.

Other features and advantages of the present invention will become apparent from the following description of the preferred embodiments, taken in conjunction with the accompanying drawings, which illustrate, by way of example, the principles of the invention.

### BRIEF DESCRIPTION OF THE DRAWINGS

FIG. 1 is a perspective view of a telephone apparatus equipped with a telephone recording announcer, push button, and sensor system.

FIG. 2 is a block diagram showing an embodiment of the voice playback circuit in the telephone recording announcer.

FIG. 3 is a block diagram showing an embodiment of the invention.

### DETAILED DESCRIPTION OF PREFERRED EMBODIMENTS

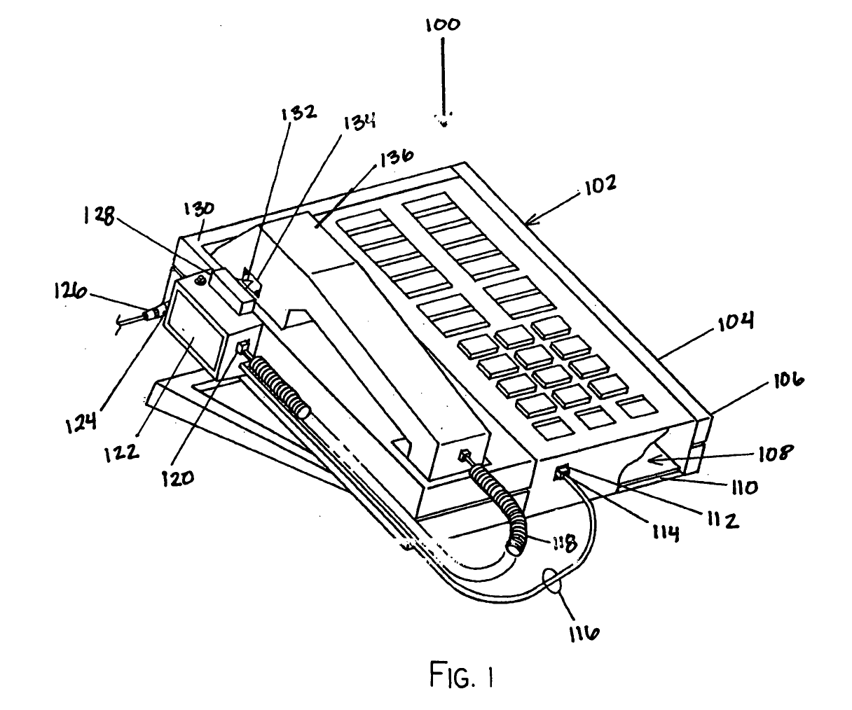

As shown in FIG. 1, the present invention is embodied in a telephone apparatus system 100 which consists of the telephone apparatus 102. The telephone apparatus 102 may include a housing 104, a base 106, an inside 108 which is covered by the housing 104, a baseplate 110, and a handset 136.

An embodiment of the invention includes a reflective target 134 on the handset 136 which reflects a beam of radiation 132 from the transmitter/detector unit 128 when the handset 136 is in an on-hook condition. Conversely, when the handset 136 is in an off-hook condition the handset 136 will not reflect a beam of radiation from the transmitter/detector unit. In an embodiment of the invention, the telephone recording announcer 122 may be placed on the side of the phone and contains the transmitter/detector unit 128. The telephone recording announcer 122 via the transmitter/detector unit 128 detects the presence or absence of the beam of radiation 132 as described briefly above and in more detail in U.S. Pat. No. 5,835,585 (to Alan P. Morse and assigned to DynaMetric, Inc., the same assignee in this Patent Application) incorporated by reference herein.

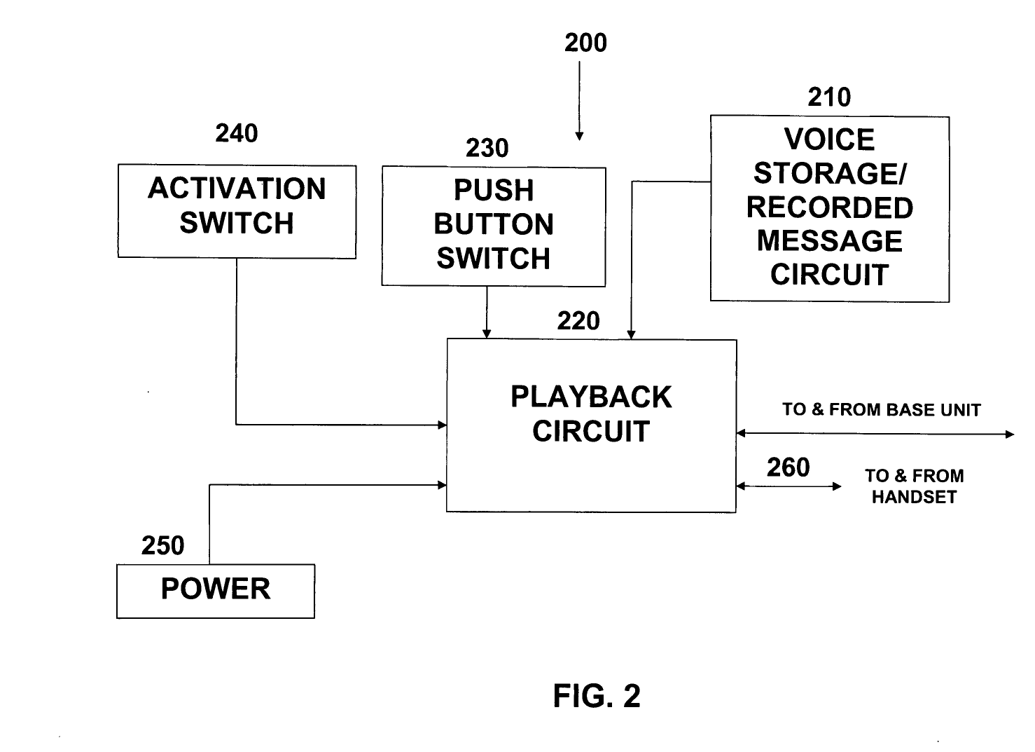

Another embodiment of the invention may be used in an upright telephone apparatus or other non-standard shaped telephone apparatus, the transmitter/detector unit contained in the telephone recording announcer may be placed in any way that would communicate with a reflective target such that the on-hook/off-hook condition of the handset or of a headset can be detected. Thus, in any embodiment of the telephone apparatus, when the beam goes from present to absent, this would trigger the voice playback circuit as shown in FIG. 2.

As further shown in FIG. 1, the telephone apparatus 102 is connected to the telephone recording announcer 122 via the coil cord 118 attached to the handset 136. Another embodiment of the invention may be compatible with a cordless telephone whereby said telephone recording announcer could be connected to the telephone utilizing wireless connections.

The telephone recording announcer 122 has a modular jack 120 which receives the modular plug of the coil cord 118. The base 106 of the telephone apparatus 102 has a base modular plug 112 which receives the standard modular plug 114 from the telephone recording announcer 122.

An embodiment of the telephone recording announcer 122 includes an input jack 124 which accepts a cable 126. The cable 126 may be attached to any power source 140 including but not limited to a 6 Volt DC power cube (not shown) plugged into a 120 Volt AC. This power source 140 energizes the transmitter/detector unit 128 (and other circuitry in the device) so that it may communicate with the reflective target 134 on the handset 136 or other location on the telephone apparatus 102 where an off-hook/on-hook condition can be sensed.

In an embodiment of the invention, there is a relay that disables the handset 136 if the unit is unplugged from the power source 140. This assures that the telephone recording announcer 122 is enabled and cannot be disabled by the operator of the telephone apparatus 102 by disconnecting power. This provides consistent delivery of the recorded message to callers.

An embodiment of the invention is shown in FIG. 2, the telephone recording announcer 122 comprises a voice integrated circuit 200. The voice storage circuit 210 and playback circuit 220 are based in the voice integrated circuit 200. The voice storage and playback circuits 210 and 220 may be programmed using input from a compact disc or other sound recording device. The activation switch 240 is triggered by an off-hook condition detected by the transmitter/detector unit.

The playback circuit 220 when triggered by the activation switch 240 or the push button switch 230 outputs the voice storage/recorded message 210 to the microphone circuit 260 of the telephone apparatus 102 located in the phone base 102. The telephone apparatus 102 then amplifies this voice storage/recorded message 210 such that it can be heard by the operator in their earphone and sent out to the caller or the recipient of the call.

Another embodiment of the invention may include a device in which the optical circuits from the transmitter/detector unit 128 are omitted thereby activating the playback circuit 220 only when the push button switch 230 is depressed. This embodiment may be used when the telephone apparatus 102 is used to make a call rather than to receive a call.

In another embodiment of the invention, volume control circuits may be coupled to the microphone circuit 260 of the telephone apparatus 102 such that the volume of the voice storage/recorded message 210 may be controlled by the volume control circuits. Consequently, the voice storage volume may be adjustable by the operator via a knob, dial, screwdriver adjustable post or any other device accessible to the user and connected to these volume control circuits.

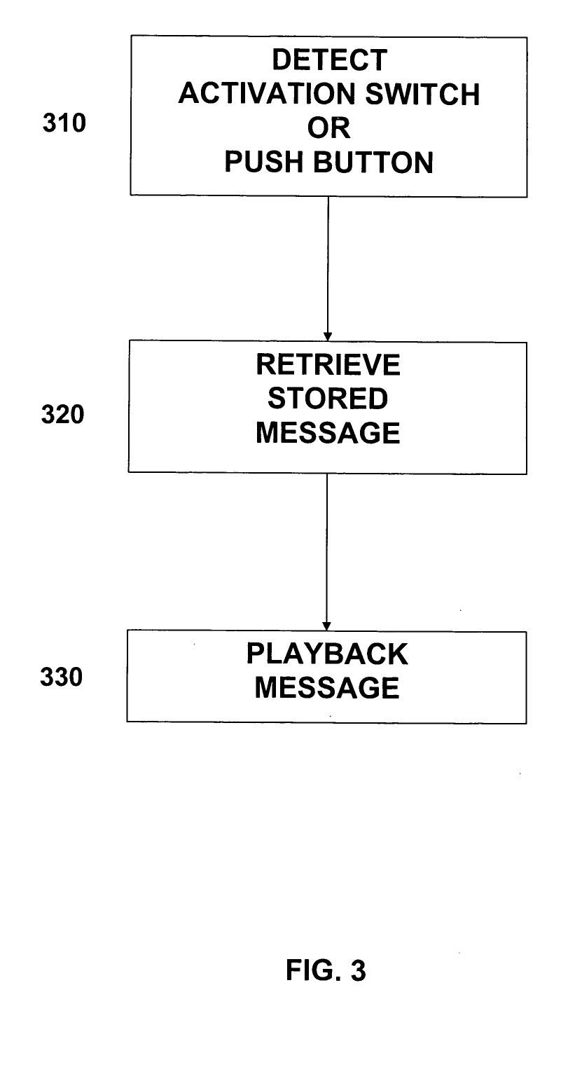

As shown in the block diagram of FIG. 3, the telephone recording announcer detects the activation switch or push button switch 310. This detection retrieves the stored message 320 which then plays back the message 330 to the caller or the recipient of the call.

While the invention has been described in connection with a preferred embodiment, it will be understood that it is not intended to cover all modifications and alternative constructions falling within the scope of the invention as expressed in the appended claims.

1. A telephone recording announcer comprising:
a switch or a plurality of switches;
a playback circuit triggered by said switch or said plurality of switches;
a voice storage circuit activated by said playback circuit;
an output circuit which audibly plays a message released from said voice storage circuit; and
a power supply.

2. The announcer of claim 1, wherein said switch is a push button switch.

3. The announcer of claim 1, wherein said switch is an activation switch linked to a telephone apparatus.

4. The activation switch of claim 3, said activation switch comprising:
a transmitter/detector unit connected to said announcer;
said transmitter/detector unit emitting a beam of radiation;
said beam of radiation reflected by a reflector located on a handset of said telephone apparatus when said handset is in an on-hook condition; and
said playback circuit activated when said beam of radiation ceases to be received by said transmitter/detector unit.

5. The announcer of claim 1, wherein said plurality of switches comprise a push button switch and an activation switch.

6. The announcer of claim 1, wherein said power source is a 6V DC power cube.

7. The announcer of claim 1 attached to a telephone apparatus via a connection from said announcer to a telephone apparatus handset and a connection from said announcer to a base unit of said telephone apparatus.

8. A telephone apparatus system comprising:
a telephone apparatus;
a telephone recording announcer comprising:
a playback circuit activated by a switch or a plurality of switches;
said playback circuit outputting a voice storage circuit to a microphone circuit of a telephone base; and
said voice storage amplified by the telephone apparatus to an earphone of said handset;
a connection from said announcer to said handset of said telephone apparatus;
a connection from said announcer to a base unit of said telephone apparatus; and
a power source.

9. The system of claim 8, wherein said switch is a push button switch.

10. The system of claim 8, wherein said handset connection is through a cord with said cord comprising a first end and a second end;
whereby said first end has a standard modular plug and said second end has a standard modular plug;
whereby said first modular plug is inserted into said handset of said telephone apparatus in a handset modular jack which accepts said first modular plug; and said second modular plug is inserted into an announcer modular jack of said announcer which accepts said second modular plug.

11. The system of claim 8, wherein said base unit connection is through a cable, said cable comprising a first end and a second end;
said first end has a standard modular plug and said second is attached to said announcer; and
said first modular plug is inserted into said base unit of said telephone apparatus in a base unit modular jack which accepts said first modular plug.

12. The system of claim 8, wherein said power source is a 6V DC power cube.

13. The system of claim 8, further comprising a volume control circuit coupled to said output circuit.

14. The volume control circuit of claim 13, further comprising a knob such that the volume can be controlled by a user of the announcer.

17. The volume control circuit of claim 13, further comprising a dial such that the volume can be controlled by the user of the announcer.

18. The system of claim 8 wherein said switch is an activation switch comprising:
a transmitter/detector unit;
whereby said transmitter/detector unit is attached to said announcer and emits a beam of radiation; and
said beam of radiation is reflected by a reflector on the handset and received by a sensor connected to said announcer when said handset is in an on-hook condition.

17. The activation switch of claim 8 wherein said beam of radiation is not received by a sensor on the handset when said handset is in an off-hook condition.

18. The activation switch of claim 8 wherein said off-hook condition activates said playback circuit.

19. The system of claim 8, wherein said plurality of switches comprise:
an activation switch comprising a transmitter/detector unit;
whereby said transmitter/detector unit is attached to said announcer and emits a beam of radiation;
said beam of radiation is reflected by a reflector on said handset when said handset is in an on-hook condition; and
said playback circuit is activated when said beam of radiation is not received by said transmitter/detector unit; and
a push button switch.

20. The system of claim 8, wherein said handset is disabled if said power source is removed.

21. A method of outputting a telephone recording comprising:
a telephone recording announcer attached to a telephone apparatus said announcer comprising:
a switch or a plurality of switches;
said switch activating a recorded message;
said recorded message outputted when an operator activates said switch or
said plurality of switches.

22. The method of claim 21, whereby said switch is an activation switch comprising:
a transmitter/detector unit whereby said transmitter/detector unit is attached to said announcer and emits a beam of radiation;
said beam of radiation is reflected by a reflector on a handset attached to said telephone apparatus when said handset is in an on-hook condition; and
said recorded message is activated when said beam of radiation is not received by said transmitter/detector unit because said handset is removed from said telephone apparatus by said operator when receiving a telephone call from a caller.

23. The method of claim 21, whereby said switch is a push button switch depressed by said operator when said operator makes a telephone call and the recipient of the call answers their telephone.

24. The method of claim 21, wherein said plurality of switches comprise:
an activation switch which comprises:
a transmitter/detector unit whereby said transmitter/detector unit is attached to said announcer and emits a beam of radiation;
said beam of radiation is reflected by a reflector on a handset attached to said telephone apparatus when said handset is in an on-hook condition; and
said recorded message is activated when said beam of radiation is not received by said transmitter/detector unit; and
a push button switch.

25. The method of claim 24, whereby the beam of radiation is omitted when said operator changes said on-hook condition of said handset when said operator is making a telephone call.
